(19) United States
(12) Patent Application Publication
(10) Pub. No.: US 2022/0315819 A1
(43) Pub. Date: Oct. 6, 2022

(54) HIGH-HUMIDITY RESISTANT SILICONE RESIN ADHESIVE COMPOSITION

(71) Applicant: SHIN-ETSU CHEMICAL CO., LTD., Tokyo (JP)

(72) Inventor: Kenichi INAFUKU, Osaka-shi (JP)

(73) Assignee: SHIN-ETSU CHEMICAL CO., LTD., Tokyo (JP)

(21) Appl. No.: 17/690,422

(22) Filed: Mar. 9, 2022

(30) Foreign Application Priority Data
Apr. 5, 2021 (JP) 2021- 63908

(51) Int. Cl. C09J 183/04; C09J 11/04

(52) U.S. Cl. CPC C09J 183/04; C09J 11/04; C09J 2483/00

(57) ABSTRACT

A high-humidity resistant silicone resin adhesive composition contains: (A) alkenyl group-containing organopolysiloxanes comprising (A1) a linear organopolysiloxane and (A2) a branched organopolysiloxane such that a mass ratio (A1)/(A2) of the (A1) and the (A2) is in a range of 1 to 10; (B) an organohydrogenpolysiloxane; (C) a platinum group metal-based catalyst; (D) a di(meth)acrylate compound; (E) an oligomer of a trimethoxysilane or trichlorosilane hydrolysate, the oligomer having at least three hydrogen atoms directly bonded to silicon atoms per molecule; and (F) an organohydrogenpolysiloxane having epoxy groups. Thus, the present invention provides a high-humidity resistant silicone resin adhesive composition for enabling tolerance in high-temperature high-humidity tests, such as PCT and HAST, conducted at high pressure.

### TECHNICAL FIELD

The present invention relates to a high-humidity resistant silicone resin adhesive composition.

### BACKGROUND ART

Silicone resins are used as adhesives in various fields including architecture, medicine, and semiconductor because cured products resulting from silicone resins are excellent in stability, such as heat resistance and light resistance, and in rubber properties, such as elongation and tensile strength.

Particularly, in the semiconductor field, since stress is increased due to increased package size and laminate structure and the driving temperature is increased, silicone resins are selected as adhesives in many cases.

However, silicone resins have high moisture permeability, and tend to have low tolerance to high-temperature high-humidity tests, such as PCT (pressure cooker test) and HAST (highly accelerated stress test), which are conducted at high pressure.

Thus, to improve the humidity resistance of silicone resins, methods have been employed in which a dehydrator or (meth)acryloyl group-containing trimethoxysilane is added (Patent Documents 1, 2).

Nevertheless, the humidity resistances attained by these methods are determined under atmospheric pressure. There is no disclosure of such resistance when silicone resins are exposed to water vapor at high temperature and high pressure.

Meanwhile, it has been disclosed that adding bis(alkoxysilyl)alkane to a condensation-curable silicone resin makes tolerable in PCT. However, condensation curing is inferior in curability at deeper portions, and is not suitable for adhesion for large area and narrow gap (Patent Document 3).

### CITATION LIST

### Patent Literature

Patent Document 1: JP 2007-191502 A
Patent Document 2: JP 2014-098129 A
Patent Document 3: JP 2010-90227 A

### SUMMARY OF INVENTION

### Technical Problem

In view of the above problems, an object of the present invention is to provide a high-humidity resistant silicone resin adhesive composition for enabling tolerance in high-temperature high-humidity tests, such as PCT and HAST, conducted at high pressure.

### Solution to Problem

To achieve the object, the present invention provides a high-humidity resistant silicone resin adhesive composition comprising:

(A) alkenyl group-containing organopolysiloxanes comprising the following (A1) and (A2),
(A1) a linear organopolysiloxane shown by the following average compositional formula (1) and having at least two alkenyl groups per molecule,

(R²R¹₂SiO_{1/2})ₐ₁(R³₂SiO_{2/2})_{b1} (1)

wherein each R¹ independently represents a group selected from a saturated aliphatic hydrocarbon group having 1 to 12 carbon atoms, an aromatic hydrocarbon group having 6 to 12 carbon atoms, and an alkoxy group having 1 to 6 carbon atoms, and these groups optionally have a substituent for at least one hydrogen atom bonded to a carbon atom,

R² represents an alkenyl group,

each R³ independently represents a group selected from a saturated aliphatic hydrocarbon group having 1 to 12 carbon atoms and an aromatic hydrocarbon group having 6 to 12 carbon atoms, and

a1 and b1 represent numbers satisfying 0<a1≤1.0, 0≤b1<1.0, and a1+b1=1.0, and
(A2) a branched organopolysiloxane shown by the following average compositional formula (2),

(R²R¹₂SiO_{1/2})ₐ₂(SiO_{4/2})_{b2} (2)

wherein R¹ and R² are as defined above, and a2 and b2 represent numbers satisfying 0<a2<1.0, 0<b2<1.0, and a2+b2=1.0,

wherein a mass ratio (A1)/(A2) of the (A1) and the (A2) is in a range of 1 to 10;

(B) an organohydrogenpolysiloxane shown by the following average compositional formula (3) and having at least two hydrogen atoms bonded to silicon atoms per molecule,

(R³₃SiO_{1/2})ₐ₃(R³HSiO_{2/2})_{b3} (3)

wherein R³ is as defined above, and a3 and b3 represent numbers satisfying 0≤a3<1.0, 0<b3≤1.0, and a3+b3=1.0;

(C) a platinum group metal-based catalyst;

(D) a di(meth)acrylate compound containing no silicon atom within a molecule;

(E) an oligomer of a trimethoxysilane or trichlorosilane hydrolysate, the oligomer having at least three hydrogen atoms directly bonded to silicon atoms per molecule; and

(F) an organohydrogenpolysiloxane shown by the following average compositional formula (4),

(R⁴₃SiO_{1/2})ₐ₄(R¹HSiO_{2/2})_{b4}(R⁴₂SiO_{2/2})_{c4} (4)

wherein R¹ is as defined above,

each R⁴ independently represents the R¹ or a group having 4 to 8 carbon atoms with an alicyclic or aliphatic epoxy group, and at least two R⁴'s are the groups with an epoxy group, and

a4, b4, and c4 represent numbers satisfying 0<a4<1.0, 0<b4<1.0, 0<c4<1.0, and a4+b4+c4=1.0.

Such a high-humidity resistant silicone resin adhesive composition enables tolerance in high-temperature high-humidity tests, such as PCT and HAST, conducted at high pressure.

Preferably, the component (B) has the hydrogen atoms bonded to silicon atoms in an amount of 0.1 to 4.0 equivalents relative to 1 equivalent of the alkenyl groups in the component (A),

the component (D) is in an amount of 0.05 to 5 parts by mass relative to 100 parts by mass of a total of the component (A) and (B),

the component (E) is in an amount of 0.05 to 5 parts by mass relative to 100 parts by mass of the total of the component (A) and (B), and

the component (F) is in an amount of 0.02 to 3 parts by mass relative to 100 parts by mass of the total of the component (A) and (B).

When the components are contained in such ranges, sufficient adhesion is achieved without adversely influencing the resin properties.

More preferably, the present invention further comprises (G) an inorganic filler.

Such a material can enhance the strength of the high-humidity resistant silicone resin adhesive composition, adjust the viscosity thereof, and color the composition.

### Advantageous Effects of Invention

The use of the inventive high-humidity resistant silicone resin adhesive composition enables the utilization of an adherend for a longer period without impairing the adhesion even in severe environmental reliability tests including high-temperature high-humidity tests, such as PCT and HAST, conducted at high pressure.

### DESCRIPTION OF EMBODIMENTS

As noted above, there have been demands for a high-humidity resistant silicone resin adhesive composition that can withstand high-temperature high-humidity tests, such as PCT and HAST, conducted at high pressure.

Hence, the present inventor and colleagues have earnestly studied and consequently found that a high-humidity resistant silicone resin adhesive composition that can tolerate high-temperature high-humidity tests at high pressure is obtained when a curable silicone resin composition containing alkenyl group-containing organopolysiloxanes, an organohydrogenpolysiloxane, and a platinum group metal-based catalyst is mixed with: a di(meth)acrylate compound containing no silicon atom within a molecule; an oligomer which is obtained by hydrolyzing trimethoxysilane or trichlorosilane, and which has at least three hydrogen atoms directly bonded to silicon atoms per molecule; and an organohydrogenpolysiloxane having epoxy groups. This finding has led to completion of the present invention.

Specifically, the present invention is a high-humidity resistant silicone resin adhesive composition comprising:

(A) alkenyl group-containing organopolysiloxanes comprising the following (A1) and (A2),
(A1) a linear organopolysiloxane shown by the following average compositional formula (1) and having at least two alkenyl groups per molecule,

(R²R¹₂SiO_{1/2})ₐ₁(R³₂SiO_{2/2})_{b1} (1)

wherein each R¹ independently represents a group selected from a saturated aliphatic hydrocarbon group having 1 to 12 carbon atoms, an aromatic hydrocarbon group having 6 to 12 carbon atoms, and an alkoxy group having 1 to 6 carbon atoms, and these groups optionally have a substituent for at least one hydrogen atom bonded to a carbon atom,

R² represents an alkenyl group,

each R³ independently represents a group selected from a saturated aliphatic hydrocarbon group having 1 to 12 carbon atoms and an aromatic hydrocarbon group having 6 to 12 carbon atoms, and

a1 and b1 represent numbers satisfying 0<a1≤1.0, 0≤b1<1.0, and a1+b1=1.0, and
(A2) a branched organopolysiloxane shown by the following average compositional formula (2),

(R²R¹₂SiO_{1/2})ₐ₂(SiO_{4/2})_{b2} (2)

wherein R¹ and R² are as defined above, and a2 and b2 represent numbers satisfying 0<a2<1.0, 0<b2<1.0, and a2+b2=1.0,

wherein a mass ratio (A1)/(A2) of the (A1) and the (A2) is in a range of 1 to 10;

(B) an organohydrogenpolysiloxane shown by the following average compositional formula (3) and having at least two hydrogen atoms bonded to silicon atoms per molecule,

(R³₃SiO_{1/2})ₐ₃(R³HSiO_{2/2})_{b3} (3)

wherein R³ is as defined above, and a3 and b3 represent numbers satisfying 0≤a3<1.0, 0<b3≤1.0, and a3+b3=1.0;

(C) a platinum group metal-based catalyst;

(D) a di(meth)acrylate compound containing no silicon atom within a molecule;

(E) an oligomer of a trimethoxysilane or trichlorosilane hydrolysate, the oligomer having at least three hydrogen atoms directly bonded to silicon atoms per molecule; and

(F) an organohydrogenpolysiloxane shown by the following average compositional formula (4),

(R⁴₃SiO_{1/2})ₐ₄(R¹HSiO_{2/2})_{b4}(R⁴₂SiO_{2/2})_{c4} (4)

wherein R¹ is as defined above,

each R⁴ independently represents the R¹ or a group having 4 to 8 carbon atoms with an alicyclic or aliphatic epoxy group, and at least two R⁴'s are the groups with an epoxy group, and

a4, b4, and c4 represent numbers satisfying 0<a4<1.0, 0<b4<1.0, 0<c4<1.0, and a4+b4+c4=1.0.

Hereinafter, the present invention will be described in detail, but the present invention is not limited to the following.

### [High-Humidity Resistant Silicone Resin Adhesive Composition]

The inventive high-humidity resistant silicone resin adhesive composition contains:

(A) a component containing the following (A1) and (A2),
(A1) a linear organopolysiloxane shown by the following average compositional formula (1) and having at least two alkenyl groups per molecule,

(R²R¹₂SiO_{1/2})ₐ₁(R³₂SiO_{2/2})_{b1} (1), and
(A2) a branched organopolysiloxane shown by the following average compositional formula (2),

(R²R¹₂SiO_{1/2})ₐ₂(SiO_{4/2})_{b2} (2);

(B) an organohydrogenpolysiloxane shown by the following average compositional formula (3) and having at least two hydrogen atoms bonded to silicon atoms per molecule,

(R³₃SiO_{1/2})ₐ₃(R³HSiO_{2/2})_{b3} (3);

(C) a platinum group metal-based catalyst;

(D) a di(meth)acrylate compound containing no silicon atom within a molecule;

(E) an oligomer of a trimethoxysilane or trichlorosilane hydrolysate, the oligomer having at least three hydrogen atoms directly bonded to silicon atoms per molecule; and

(F) an organohydrogenpolysiloxane shown by the following average compositional formula (4),

(R⁴₃SiO_{1/2})ₐ₄(R¹HSiO_{2/2})_{b4}(R⁴₂SiO_{2/2})_{c4} (4).

Such a high-humidity resistant silicone resin adhesive composition successfully suppresses a decrease in the adhesive strength to 20% or less even in a highly accelerated stress test, for example, at 130° C. and 85% RH.

The component (A), (B), (C), (D), (E), (F) and other components will be described hereinbelow.

### [Component (A)]

The component (A) is alkenyl group-containing organopolysiloxanes including the following components (A1) and (A2).

### (Component (A1))

The component (A1) is a component for imparting flowability and flexibility to the inventive composition. The component (A1) is a linear organopolysiloxane shown by the following average compositional formula (1) and having at least two alkenyl groups per molecule. Together with the component (A2) to be described later, the component (A1) serves as a base polymer of the inventive high-humidity resistant silicone resin adhesive composition.

(R²R¹₂SiO_{1/2})ₐ₁(R³₂SiO_{2/2})_{b1} (1)

In the formula, each R¹ independently represents a group selected from a saturated aliphatic hydrocarbon group having 1 to 12 carbon atoms, an aromatic hydrocarbon group having 6 to 12 carbon atoms, and an alkoxy group having 1 to 6 carbon atoms. These groups optionally have a substituent in place of at least one hydrogen atom bonded to a carbon atom therein. R² represents an alkenyl group. Each R³ independently represents a group selected from a saturated aliphatic hydrocarbon group having 1 to 12 carbon atoms and an aromatic hydrocarbon group having 6 to 12 carbon atoms. a1 and b1 represent numbers satisfying 0<a1≤1.0, 0≤b1<1.0, and a1+b1=1.0.

In the average compositional formula (1), R¹'s each independently represent a group selected from a saturated aliphatic hydrocarbon group having 1 to 12 carbon atoms, an aromatic hydrocarbon group having 6 to 12 carbon atoms, and an alkoxy group having 1 to 6 carbon atoms. At least one hydrogen atom bonded to a carbon atom in these groups is optionally substituted. Examples of such R¹ include: alkyl groups, such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; cycloalkyl groups, such as a cyclopentyl group, a cyclohexyl group, and a cycloheptyl group; aryl groups, such as a phenyl group, a tolyl group, a xylyl group, a naphthyl group, and a biphenylyl group; aralkyl groups, such as a benzyl group, a phenylethyl group, a phenylpropyl group, and a methylbenzyl group; and groups obtained from these groups by substituting at least one hydrogen atom bonded to a carbon atom therein with a cyano group, a halogen atom, such as fluorine, chlorine, and bromine, or the like. Examples of such substituted groups include a chloromethyl group, a 2-bromoethyl group, a 3-chloropropyl group, a 3,3,3-trifluoropropyl group, a chlorophenyl group, a fluorophenyl group, a cyanoethyl group, a 3,3,4,4,5,5,6,6,6-nonafluorohexyl group, other halogen-substituted alkyl groups, cyano-substituted alkyl groups, halogen-substituted aryl groups, etc. In R¹, the number of carbon atoms is preferably 1 to 10, particularly preferably 1 to 6. R¹ is more preferably an unsubstituted or substituted alkyl group having 1 to 3 carbon atoms, such as a methyl group, an ethyl group, a propyl group, a chloromethyl group, a bromoethyl group, a 3,3,3-trifluoropropyl group, and a cyanoethyl group; and an unsubstituted or substituted phenyl group, such as a phenyl group, a chlorophenyl group, and a fluorophenyl group. Among these, a methyl group is particularly preferable.

In the average compositional formula (1), R² is an alkenyl group. Examples of such R² include: alkenyl groups having 2 to 8 carbon atoms, such as a vinyl group, an allyl group, a propenyl group, an isopropenyl group, a butenyl group, and a hexenyl group; and cycloalkenyl groups having 3 to 8 carbon atoms, such as a cyclohexenyl group. Among these, a vinyl group and an allyl group are preferable.

In the average compositional formula (1), R³'s each independently represent a group selected from a saturated aliphatic hydrocarbon group having 1 to 12 carbon atoms and an aromatic hydrocarbon group having 6 to 12 carbon atoms. Examples of such R³ can include: alkyl groups, such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; and cycloalkyl groups, such as a cyclopentyl group, a cyclohexyl group, and a cycloheptyl group. Among these, R³ preferably has 1 to 6 carbon atoms, and is further preferably a methyl group, an ethyl group, a cyclopentyl group, or a cyclohexyl group.

The viscosity of the component (A1) at 23° C. is not particularly limited, but is preferably within a range of 100 to 100,000 mPa·s, particularly preferably within a range of 100 to 50,000 mPa·s, from the viewpoints of imparting flowability and flexibility to the high-humidity resistant silicone resin adhesive composition. When the viscosity is in these ranges, the resulting silicone resin adhesive composition is easy to handle.

Note that the viscosity refers to absolute viscosity at 23° C. measured according to the method described in JIS K 7117-1:1999.

### (Component (A2))

The component (A2) is a branched organopolysiloxane shown by the following average compositional formula (2):

(R²R¹₂SiO_{1/2})ₐ₂(SiO_{4/2})_{b2} (2)

In the formula, R¹ and R² are as defined above. a2 and b2 represent numbers satisfying 0<a2<1.0, 0<b2<1.0, and a2+b2=1.0. The component (A2) is blended to improve the physical strength and surface tackiness of the resulting cured product. As described above, the component (A2) is an organopolysiloxane of a resin structure having two or more alkenyl groups per molecule, and used together with the component (A1) as the base polymer of the inventive composition. Basically, the component (A2) is composed of repeated SiO₂ units and has a branched structure whose terminal is blocked with a triorganosiloxy group.

The branched organopolysiloxane of the component (A2) is blended in such an amount that a mass ratio (A1)/(A2) in the component (A) is in a range of 1 to 10. If the branched organopolysiloxane is blended too little, the sufficient curing may not be achieved. If the amount is too much, the composition will have considerably high hardness, so that the cured product is likely to crack in some cases.

The ratio of b2 relative to a2 in the average compositional formula (2) of the component (A2) is preferably 0.1 to 2.0, further preferably 0.1 to 1.5.

### [Component (B)]

The component (B) is a curing agent and reacts with the component (A). The component (B) is an organohydrogenpolysiloxane shown by the following average compositional formula (3) and has at least two, preferably three or more, hydrogen atoms bonded to silicon atoms (SiH groups) per molecule.

(R³₃SiO_{1/2})ₐ₃(R³HSiO_{2/2})_{b3} (3)

In the formula, R³ is as defined above. a3 and b3 represent numbers satisfying 0≤a3<1.0, 0<b3≤1.0, and a3+b3=1.0.

The amount of the component (B) blended is not particularly limited, but the component (B) has hydrogen atoms bonded to silicon atoms in an amount of preferably 0.1 to 4.0 equivalents, more preferably 1.0 to 3.0 equivalents, relative to 1 equivalent of the alkenyl groups in the component (A). The component (B) may have either linear or cyclic (a3=0) structure.

Examples of the R³ in the average compositional formula (3) can include: alkyl groups, such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; and cycloalkyl groups, such as a cyclopentyl group, a cyclohexyl group, and a cycloheptyl group. Among these, R³ preferably has 1 to 6 carbon atoms, and is further preferably a methyl group, an ethyl group, a cyclopentyl group, or a cyclohexyl group.

The component (B) has a viscosity at 23° C. within a range of preferably 1 to 100 mPa·s, particularly preferably 1 to 10 mPa·s. Note that the viscosity is measured as mentioned above.

### [Component (C)]

The component (C) is a platinum group metal-based catalyst for promoting the addition reaction (hydrosilylation reaction) between alkenyl groups in the component (A) and SiH groups in the component (B) and further in the components (E) and (F) to be described later. Well-known catalysts for hydrosilylation reaction can be used. Specific examples thereof include platinum group metal simple substances, such as platinum (including platinum black), rhodium, and palladium; platinum chloride, chloroplatinic acid, and chloroplatinate, such as H₂PtCl₄.nH₂O, H₂PtCl₆.nH₂O, NaHPtCl₆.nH₂O, KHPtCl₆.nH₂O, Na₂PtCl₆.nH₂O, K₂PtCl₄.nH₂O, PtCl₄.nH₂O, PtCl₂, and Na₂HPtCl₄.nH₂O (where “n” represents an integer of 0 to 6, preferably 0 or 6); alcohol-modified chloroplatinic acid (see the specification of U.S. Pat. No. 3,220,972); complexes of chloroplatinic acid with olefin (see the specifications of U.S. Pat. Nos. 3,159,601, 3,159,662 and 3,775,452); ones obtained by supporting a platinum group metal, such as platinum black and palladium, on a support, such as alumina, silica, and carbon; rhodium-olefin complex; chlorotris(triphenylphosphine)rhodium (Wilkinson catalyst); complexes of platinum chloride, chloroplatinic acid, or chloroplatinate with a vinyl group-containing siloxane, particularly a vinyl group-containing cyclic siloxane; etc.

The component (C) may be blended in an amount of what is called catalytic amount. Normally, the amount is preferably 0.1 to 1,000 ppm, particularly preferably about 0.5 to 500 ppm, based on the mass of the platinum group metal relative to the total amount of the components (A) and (B).

### [Component (D)]

The component (D) is a component for imparting adhesion to the inventive composition, and is a di(meth)acrylate compound containing no silicon atom within a molecule. The component (D) is a compound compatible with the components (A) and (B).

Examples of such component (D) include diethylene glycol di(meth)acrylate, triethylene glycol di(meth)acrylate, tetraethylene glycol di(meth)acrylate, polyethylene glycol di(meth)acrylate, di(meth)acrylic acid ester of 5-ethyl-2-(2-hydroxy-1,1-dimethylethyl)-5-(hydroxymethyl)-1,3-dioxane, 2-propenoic acid (octahydro-4,7-methano-1H-indenediyl)bis(methylene) ester (trade name: KAYARAD R-684, available from Nippon Kayaku Co., Ltd.) or corresponding methacrylic acid ester thereof, other bifunctional (meth)acrylates, etc.

The component (D) is blended in an amount of preferably 0.05 to 5 parts by mass, more preferably 0.5 to 2 parts by mass, relative to 100 parts by mass of the total of the component (A) and (B). When the amount is the lower limit value or more, sufficient adhesion is achieved. When the amount is the upper limit value or less, the resin properties of the cured product will not be adversely influenced.

### [Component (E)]

The component (E) is a component for imparting adhesion to the inventive composition, and is an oligomer of a trimethoxysilane or trichlorosilane hydrolysate. The oligomer has at least three hydrogen atoms directly bonded to silicon atoms (SiH groups) per molecule.

The component (E) is blended in an amount of preferably 0.05 to 5 parts by mass, more preferably 0.5 to 2 parts by mass, relative to 100 parts by mass of the total of the component (A) and (B). When the amount is the lower limit value or more, sufficient adhesion is achieved. When the amount is the upper limit value or less, the resin properties of the cured product will not be adversely influenced.

### [Component (F)]

The component (F) is an organohydrogenpolysiloxane shown by the following average compositional formula (4).

(R⁴₃SiO_{1/2})ₐ₄(R¹HSiO_{2/2})_{b4}(R⁴₂SiO_{2/2})_{c4} (4)

In the formula, R¹ is as defined above. Each R⁴ independently represents the R¹ or a group having 4 to 8 carbon atoms with an alicyclic or aliphatic epoxy group. At least two R⁴'s are the groups with such epoxy groups. a4, b4, and c4 represent numbers satisfying 0<a4<1.0, 0<b4<1.0, 0<c4<1.0, and a4+b4+c4=1.0.

Such component (F) is a component for imparting adhesion to the composition, and is a compound (for example, polymer) containing an epoxy group and a hydrogen atom directly bonded to a silicon atom (SiH group) in one molecule.

Examples of the component (F) include structures as follows.

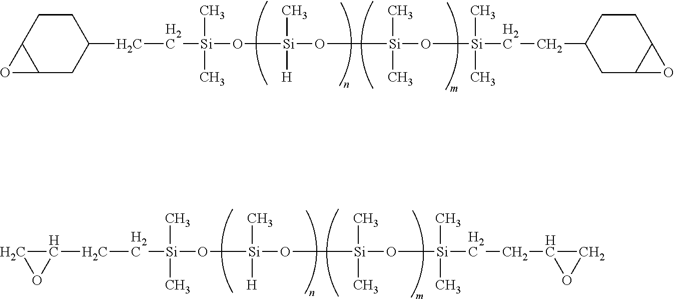

In the formulae, “n” and “m” each represent an integer of 1 or more.

The component (F) is blended in an amount of preferably 0.02 to 3 parts by mass, more preferably 0.02 to 1 part(s) by mass, relative to 100 parts by mass of the total of the component (A) and (B). When the amount is the lower limit value or more, sufficient adhesion is achieved. When the amount is the upper limit value or less, the resin properties of the cured product will not be adversely influenced.

### [Other Components]

The inventive high-humidity resistant silicone resin adhesive composition can contain the following components as necessary, besides the above-described components (A) to (F).

### [Component (G)]

A component (G) is an inorganic filler and can be added to increase the strength of the inventive high-humidity resistant silicone resin adhesive composition, color the composition, or adjust the viscosity.

Examples of such component (G) include fumed silica, crystalline silica, precipitated silica, hollow filler, fumed titanium dioxide, magnesium oxide, zinc oxide, iron oxide, aluminum hydroxide, magnesium carbonate, calcium carbonate, zinc carbonate, lamellar mica, carbon black, diatomaceous earth, glass fiber, etc.

### [Other Additives]

The high-humidity resistant silicone resin adhesive composition may contain, as necessary, a compound having an effect of suppressing or controlling the curing reaction, other than the components (A) to (G). Examples of such a compound include: phosphorus-containing compounds, such as triphenylphosphine; nitrogen-containing compounds, such as tributylamine, tetramethylethylenediamine, and benzotriazole; sulfur-containing compounds; acetylene-based compounds, such as ethynylcyclohexanol; compound having two or more alkenyl groups; hydroperoxy compounds; maleic acid derivatives; etc. The degree of the curing retarding effect by these compounds greatly varies depending on the chemical structures thereof. Thus, the amount of these compounds to be added should be adjusted to the optimum amount for each compound to be used. Generally, when the compound is added in a sufficient amount, this makes it possible to obtain long-term storage stability at room temperature and surely prevents curing inhibition.

Further, in order to adjust the hardness of the silicone cured product, for example, the inventive high-humidity resistant silicone resin adhesive composition may contain, appropriately as necessary, an organopolysiloxane containing one hydrogen atom bonded to a silicon atom (SiH group) per molecule other than the components (B), (E), and (F), a non-crosslinkable organopolysiloxane containing neither an alkenyl group nor a hydrogen atom bonded to a silicon atom, an organic solvent, an anti-creep hardening agent, a heat resistance-imparting agent, a flame retardant, a plasticizer, an anti-mold agent, etc.

### [Method for Preparing High-Humidity Resistant Silicone Resin Adhesive Composition]

The inventive high-humidity resistant silicone resin adhesive composition can be prepared by blending the above-described components at a predetermined composition ratio, and uniformly mixing the components in accordance with a conventional method by using a planetary mixer, a Shinagawa mixer, or the like.

The inventive high-humidity resistant silicone resin adhesive composition is a stable adhesive capable of tolerating high-temperature high-humidity tests at high pressure, and exhibits excellent durability in reliability tests for semiconductor parts, such as PCT, HAST, TCT (temperature cycle test), and high-temperature storage test.

### EXAMPLE

Hereinafter, the present invention will be described in detail by showing Examples and Comparative Examples. However, the present invention is not limited to the following Examples. Hereinbelow, part(s) mean part(s) by mass. The viscosity refers to absolute viscosity at 23° C. measured according to the method described in JIS K 7117-1:1999 (unless otherwise particularly stated, measured with a Brookfield digital viscometer DV-II+Pro). The weight-average molecular weight was measured by gel permeation chromatography (GPC) in terms of polystyrene.

### Preparation Examples 1 to 7

Components as follows were prepared and mixed in parts shown later in Table 1 to obtain Silicone resin adhesive compositions 1 to 7.

### (A1) Alkenyl Group-Containing Linear Organopolysiloxane

Polydimethylsiloxane having an alkenyl group amount of 0.005 mol per 100 g and a viscosity of 10,000 mPa·s, in which both terminals of the molecular chain were blocked with vinyl groups (in the average compositional formula (1), all R¹'s and R³'s were methyl groups, all R²'s were vinyl groups, and b1/a1=260; the polydimethylsiloxane was manufactured by Shin-Etsu Chemical Co., Ltd.)

### (A2) Alkenyl Group-Containing Branched (Resin Structure) Organopolysiloxane

Organopolysiloxane having a resin structure, an alkenyl group amount of 0.1 mol per 100 g, and a weight-average molecular weight of 5,500 (in the average compositional formula (2), all R¹'s were methyl groups, all R²'s were vinyl groups, and a2/b2=1.2; the polydimethylsiloxane was manufactured by Shin-Etsu Chemical Co., Ltd.)

### (B) Organohydrogenpolysiloxane

Methylhydrogenpolysiloxane shown by the following formula (in the average compositional formula (3), all R³'s were methyl groups, and b3/a3=19, SiH group content: 1.56 mol/100 g, viscosity: 5 mPa·s; the methylhydrogenpolysiloxane was manufactured by Shin-Etsu Chemical Co., Ltd.)

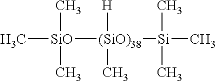

### (C) Platinum Metal Catalyst

Platinum-vinylsiloxane complex (platinum concentration: 1 mass %, manufactured by Shin-Etsu Chemical Co., Ltd.)

### (D) Di(Meth)Acrylate Compound

The component (D): a compound shown by the following formula (manufactured by Kyoeisha Chemical Co., Ltd.)

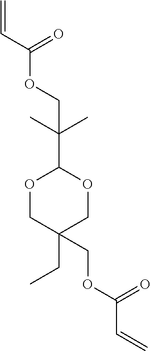 [SMILES: C=CC(=O)OCC1(CC)COC(C(C)(C)COC(=O)C=C)OC1]

### (E) Oligomer of Trimethoxysilane or Trichlorosilane Hydrolysate (Organohydrogensiloxane Oligomer)

The component (E): a compound shown by the following formula (SiH group content: 1.29 mol/100 g, kinematic viscosity: 1.2 mm²/s (measured with a capillary viscometer), manufactured by Shin-Etsu Chemical Co., Ltd.)

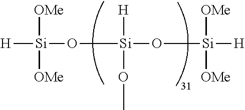

### (F) Epoxy Group-Containing Organohydrogenpolysiloxane

The component (F): a compound shown by the following formula (in the average compositional formula (4), all R¹'s were methyl groups, one of R⁴'s in a single (R⁴₃SiO_{1/2}) unit was a group with an epoxy group while the other two were methyl groups, all R⁴'s in any (R⁴₂SiO_{2/2}) unit were methyl group, a4=0.1, b4=0.3, and c4=0.6, SiH group content: 0.0035 mol/100 g, kinematic viscosity: 64 mm²/s (measured with a capillary viscometer); the organohydrogenpolysiloxane was manufactured by Shin-Etsu Chemical Co., Ltd.)

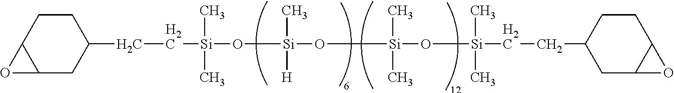

### (G) Inorganic Filler

The component (G): fumed silica (Mu-sil 130A manufactured by Shin-Etsu Chemical Co., Ltd.)

### Other Component

Curing inhibitor: ethynylcyclohexanol

The above components (A) to (G) were mixed in amounts of parts by mass as shown below in Table 1. Thus, Silicone resin adhesive compositions 1 to 7 were obtained. Note that, in each composition, H/Vi refers to SiH/SiVi ratio (molar ratio of all SiH groups in the components (B), (E), (F) relative to 1 mol of the alkenyl groups in the component (A)). Moreover, H/Vi(B) refers to SiH/SiVi ratio of the component (B) in each composition (molar ratio of SiH groups in the component (B) relative to 1 mol of the alkenyl groups in the component (A)).

TABLE 1

| | Preparation | Preparation | Preparation | Preparation | Preparation | Preparation | Preparation |
|---|---|---|---|---|---|---|---|
| | Example 1 | Example 2 | Example 3 | Example 4 | Example 5 | Example 6 | Example 7 |
| Silicone | 1 | 2 | 3 | 4 | 5 | 6 | 7 |
| resin | | | | | | | |
| adhesive | | | | | | | |
| ccmposition | | | | | | | |
| Component | 75 | | | | | | |
| (A1) | | | | | | | |
| Ccaponent | 10 | | | | | | |
| (A2) | | | | | | | |
| Component | 1.7 | 1.5 | 1.9 | 1.3 | 2.1 | 1.3 | 2.1 |
| (B) | | | | | | | |
| Component | 0.3 | | | | | | |
| (C) | | | | | | | |
| Component | 0.8 | 0.5 | 1.1 | 0 | 1.6 | 0.5 | 1.1 |
| (D) | | | | | | | |
| Component | 0.8 | 1.1 | 0.5 | 1.6 | 0 | 1.1 | 0.5 |
| (E) | | | | | | | |
| Component | 0.6 | 0.6 | 0.6 | 0.6 | 0.6 | 0 | 0 |
| (F) | | | | | | | |
| Component | 11 | | | | | | |
| (G) | | | | | | | |
| Curing | 0.3 | | | | | | |
| inhibitor | | | | | | | |
| H/Vi | 2.7 | 2.7 | 2.6 | 3.0 | 2.4 | 3.6 | 2.9 |
| H/Vi (B) | 1.9 | 1.7 | 2.2 | 1.5 | 2.4 | 1.5 | 2.4 |

### Examples 1 to 3, Comparative Examples 1 to 4

One of Silicone resin adhesive compositions 1 to 7 obtained by Preparation Examples described above was poured into a mold made of a Teflon (registered trademark) plate so as to form sheets each with a thickness of 2 mm, and heated with an oven at 180° C. for 1 hour. Thereby, sheet-formed cured products were obtained.

Three sheets of the sheet-formed cured products were laid on one another such that the laminate had a thickness of 6 mm. The hardness was measured with a durometer type A according to JIS K 6249. Table 2 shows the measurement result.

One of Silicone resin adhesive compositions 1 to 7 obtained by Preparation Examples described above was sandwiched between a nickel-plated copper plate with a thickness of 0.3 mm and a silicon wafer piece with a size of 3 mm×3 mm such that the insert had a thickness of 0.2 mm. The resultant was heated with an oven at 180° C. for 1 hour. In this manner, adhesion test pieces were obtained.

The adhesive strength of each adhesion test piece was measured according to IEC 60749-19 using a bond tester (Dage 4000 manufactured by Nordson Advanced Technology K.K.). Table 2 shows the measurement result.

The adhesion test piece was placed in a HAST chamber (PC-242HSR2 manufactured by HIRAYAMA Manufacturing Corporation) and treated under conditions of 130° C. and 85% RH for 168 hours.

The adhesive strength of each adhesion test piece thus treated was measured in the same manner for the products before the treatment. Table 2 shows the measurement result.

TABLE 2

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| | Preparation | Preparation | Preparation | Preparation | Preparation | Preparation | Preparation |
| Composition | Example 1 | Example 2 | Example 3 | Example 4 | Example 5 | Example 6 | Example 7 |
| Hardness | 63 | 60 | 70 | 60 | 69 | 60 | 70 |
| Adhesive | 5.7 | 5.5 | 6.0 | 5.7 | 6.0 | 5.7 | 6.0 |
| strength | | | | | | | |
| (Mpa) | | | | | | | |
| before HAST | | | | | | | |
| Failure mode | A | A | A | A | A | A | A |
| before HAST | | | | | | | |
| Adhesive | 5.4 | 5.4 | 5.5 | 1.1 | 0.8 | 0.8 | 0.7 |
| strength | | | | | | | |
| (MPa) | | | | | | | |
| after HAST | | | | | | | |
| Failure mode | A | A | A | B | B | B | B |
| after HAST | | | | | | | |

Here, as the failure mode, “A” indicates cohesive failure, while “B” indicates adhesive failure.

As shown in Table 2, after the humidification-heating treatment at 130° C. and 85% RH for 168 hours, the adhesion test pieces obtained by curing the inventive silicone resin adhesive compositions successfully kept 80% or more of the initial values of the adhesive strengths. This revealed that by incorporating all of the di(meth)acrylate compound of the component (D), the organohydrogensiloxane oligomer (branched organohydrogenpolysiloxane) of the component (E), and the organohydrogenpolysiloxane containing epoxy groups of the component (F), the inventive high-humidity resistant silicone resin adhesive compositions are capable of suppressing a decrease in the adhesion between before and after the HAST.

In contrast, it was observed that the adhesive strengths were decreased after the HAST in Comparative Examples 1 to 4 not incorporating all of the di(meth)acrylate compound of the component (D), the organohydrogensiloxane oligomer of the component (E), and the organohydrogenpolysiloxane containing epoxy groups of the component (F).

This indicates that when all the components (D), (E), and (F) for imparting adhesion to the inventive composition are blended, the resistance to high temperature and high humidity at high pressure as described above is demonstrated by the synergistic effect from the combination of the component (D) compatible with the components (A) and (B), the component (E) functioning as a crosslinking agent (curing agent) of the component (A), and the component (F) having active epoxy groups.

From these results, the inventive silicone resin adhesive compositions exhibit excellent humidity resistance, and thus are suitable as adhesives for members which are required to have high reliability, such as vehicle-mounted semiconductors, medical devices, etc.

It should be noted that the present invention is not limited to the above-described embodiments. The embodiments are just examples, and any embodiments that substantially have the same feature and demonstrate the same functions and effects as those in the technical concept disclosed in claims of the present invention are included in the technical scope of the present invention.

1. A high-humidity resistant silicone resin adhesive composition comprising:
(A) alkenyl group-containing organopolysiloxanes comprising the following (A1) and (A2),
(A1) a linear organopolysiloxane shown by the following average compositional formula (1) and having at least two alkenyl groups per molecule,
(R²R¹₂SiO_{1/2})ₐ₁(R³₂SiO_{2/2})_{b1} (1)
wherein each R¹ independently represents a group selected from a saturated aliphatic hydrocarbon group having 1 to 12 carbon atoms, an aromatic hydrocarbon group having 6 to 12 carbon atoms, and an alkoxy group having 1 to 6 carbon atoms, and these groups optionally have a substituent for at least one hydrogen atom bonded to a carbon atom,
R² represents an alkenyl group,
each R³ independently represents a group selected from a saturated aliphatic hydrocarbon group having 1 to 12 carbon atoms and an aromatic hydrocarbon group having 6 to 12 carbon atoms, and
a1 and b1 represent numbers satisfying 0<a1≤1.0, 0≤b1<1.0, and a1+b1=1.0, and
(A2) a branched organopolysiloxane shown by the following average compositional formula (2),
(R²R¹₂SiO_{1/2})ₐ₂(SiO_{4/2})_{b2} (2)
wherein R¹ and R² are as defined above, and a2 and b2 represent numbers satisfying 0<a2<1.0, 0<b2<1.0, and a2+b2=1.0,
wherein a mass ratio (A1)/(A2) of the (A1) and the (A2) is in a range of 1 to 10;
(B) an organohydrogenpolysiloxane shown by the following average compositional formula (3) and having at least two hydrogen atoms bonded to silicon atoms per molecule,
(R³₃SiO_{1/2})ₐ₃(R³HSiO_{2/2})_{b3} (3)
wherein R³ is as defined above, and a3 and b3 represent numbers satisfying 0≤a3<1.0, 0<b3≤1.0, and a3+b3=1.0;
(C) a platinum group metal-based catalyst;
(D) a di(meth)acrylate compound containing no silicon atom within a molecule;
(E) an oligomer of a trimethoxysilane or trichlorosilane hydrolysate, the oligomer having at least three hydrogen atoms directly bonded to silicon atoms per molecule; and
(F) an organohydrogenpolysiloxane shown by the following average compositional formula (4),
(R⁴₃SiO_{1/2})ₐ₄(R¹HSiO_{2/2})_{b4}(R⁴₂SiO_{2/2})_{c4} (4)
wherein R¹ is as defined above,
each R⁴ independently represents the R¹ or a group having 4 to 8 carbon atoms with an alicyclic or aliphatic epoxy group, and at least two R⁴'s are the groups with an epoxy group, and
a4, b4, and c4 represent numbers satisfying 0<a4<1.0, 0<b4<1.0, 0<c4<1.0, and a4+b4+c4=1.0.

2. The high-humidity resistant silicone resin adhesive composition according to claim 1, wherein
the component (B) has the hydrogen atoms bonded to silicon atoms in an amount of 0.1 to 4.0 equivalents relative to 1 equivalent of the alkenyl groups in the component (A),
the component (D) is in an amount of 0.05 to 5 parts by mass relative to 100 parts by mass of a total of the component (A) and (B),
the component (E) is in an amount of 0.05 to 5 parts by mass relative to 100 parts by mass of the total of the component (A) and (B), and
the component (F) is in an amount of 0.02 to 3 parts by mass relative to 100 parts by mass of the total of the component (A) and (B).

3. The high-humidity resistant silicone resin adhesive composition according to claim 1, further comprising (G) an inorganic filler.

4. The high-humidity resistant silicone resin adhesive composition according to claim 2, further comprising (G) an inorganic filler.
